(19) United States
(12) Patent Application Publication
(10) Pub. No.: US 2026/0161979 A1
(43) Pub. Date: Jun. 11, 2026

(54) SYSTEMS AND METHODS FOR SCALING INFERENCES BY A MACHINE LEARNING SYSTEM

(71) Applicant: Stripe Inc., South San Francisco, CA (US)

(72) Inventors: Simon BERREBI, Seattle, WA (US); Cecilia LEUNG, Kirkland, WA (US); Carlyle NICOLL, Seattle, WA (US); Hong Chun LEUNG, San Francisco, CA (US); Radhika MODY, Pittsburgh, PA (US); Thomas POOLE, New Hope, PA (US); Chiranth HEGDE, Seattle, WA (US); Stathis VAFEIAS, San Francisco, CA (US)

(73) Assignee: Stripe Inc., South San Francisco, CA (US)

(21) Appl. No.: 18/988,304

(22) Filed: Dec. 19, 2024

(30) Foreign Application Priority Data
Dec. 10, 2024 (GR) 000005754

(51) Int. Cl. G06N 5/046; G06F 40/40

(52) U.S. Cl. CPC G06N 5/046; G06F 40/40

(57) ABSTRACT

Disclosed herein are systems and methods for accurately determining a categorization of a network operation based on requestor information rather than network-operation-specific information. One embodiment of the systems and methods disclosed herein features a server configured to transmit an ordered set of prompts to a large language model (LLM) to cause the LLM to determine a general network service description of the requesting computing infrastructure that may be applied to many (if not all) network operation requests originating from the requesting computing infrastructure. The LLM may also output a confidence score corresponding to the previously determined general network service description. The server may compare the confidence score to a calibrated accuracy threshold to determine whether to use, store, and/or transmit the determined network service description

### CROSS-REFERENCE TO RELATED APPLICATIONS

This application claims priority to Greek Patent App. No. 000005754, filed Dec. 10, 2024, which is incorporated herein by reference in its entirety for all purposes.

### BACKGROUND

Properly categorizing a network operation being executed between computer infrastructures has proven to be technically challenging when the originating request to execute the network operation lacks sufficiently detailed information about the network operation itself. For example, traditional machine learning models, such as large language models (LLMs), are trained to extract data related to the network operation from the request to execute the network operation. This extracted data is traditionally used to categorize the network operation, or in some instances, apply a description and/or attribute to the network operation. When an explicit categorization or sufficiently descriptive details/data about the network operation is not included in the request to execute the network operation, these machine learning models may fail.

Overcoming these failings proves to be technically challenging. For example, requesting additional information from the requesting computing infrastructure may require modification of current communication channels (e.g., application programming interfaces or APIs), which requires additional computing resources to implement and may require operational downtime to deploy. Further, including additional information in the request to execute the network operation requires additional computing resources because more data is being transmitted. This leads to higher latency and decreased computational efficiency.

In some instances, a machine learning model may be trained to predict/determine the category and/or attribute of the network operation based on the limited network operation information provided in conventional systems. However, accurately determining a network operation category and/or attribute based on incomplete information similarly suffers from technical challenges. For example, the machine learning model may output overly broad or inaccurate categorizations of the network when the model lacks sufficient information to generate an accurate output. These overly broad or inaccurate categorizations may be irrelevant or factually incorrect and may corrupt the accuracy of downstream data utilizing the overly broad/irrelevant/inaccurate category. To output more accurate results, the machine learning model may need to ingest additional information (at times, substantially more) which must then be used to further train the model, which substantially increases the use of computational resources and again, the computational latency.

At times, the machine learning model's overly broad or inaccurate categorizations of the network operation may be caused by the model generating hallucinated content—output that may be irrelevant or factually incorrect to the intended input and desired outcome. In the systems and methods described herein, “hallucination” generally refers to an output (e.g., text, audio, visual) generated by a machine learning model that is not faithful to the source or input text, is not justified by the training data, or is factually inaccurate. Further still, traditional machine learning models are unable to evaluate their own outputs to accurately indicate when an output is hallucinated. Hallucinations in machine learning models—and their inability to accurately detect their own hallucinations—are caused by technical shortcomings of traditional LLMs.

For example, traditional LLMs are trained on voluminous amounts of data which can demand substantial computing resources and time, which are not always available or viable due to processing and time constraints of conventional processing units. Traditional efforts to mitigate hallucinations involve testing the outputs of an LLM against known ground truth responses corresponding to similar inputs. When hallucinations are identified (e.g., the LLM output does not correspond to the ground truth), the model may undergo additional or alternative training aimed at improving its accuracy. At times this additional or alternative training is executed with human intervention. At other times, additional or alternative training is done without human intervention. In both instances, the training is constrained by the technical limitations of the amount of data that can be stored, processed, and labeled (e.g., as ground truth), thereby severely limiting scalability and reliability of the LLM. In specialized LLMs, specialized training data may be used during training in an attempt to reduce hallucinated outputs and enhance model reliability.

Despite these efforts, hallucinations remain a known and persistent technical problem in LLMs. A hallucinated response can be particularly problematic when stated with certainty by the LLM, potentially misleads users and leading to distrust of the LLM or entity utilizing the output. Therefore, conventional LLMs and other machine learning models do not provide sufficiently consistent reliable outputs without hallucination, yet still require high computing resources. As a result, existing LLMs cannot be consistently and confidently used when the output is sensitive to accuracy, such as when categorizing network operations.

Further still, it may be computationally inefficient to predict, store, and use a categorization that accurately describes only a single network operation originating from a computing infrastructure, thus requiring a separate prediction and/or storing of each individual network operation being executed over the network.

### SUMMARY

The systems and methods described herein address one or more of the technical challenges/inefficiencies that hinder traditional approaches to accurately categorizing a network operation based on limited network-operation-specific information. For example, the systems and methods described herein may employ a multi-layered approach to refine and verify an LLM prediction of a category of a network operation based on incomplete information related to the network operation. The disclosed systems and methods may use a machine learning paradigm to sequentially prompt an LLM to predict a category of the network operation based on known requestor information rather than specific network operation information. This requestor-based approach to categorization of individual network operations may, in some implementations, reduce the need for requestors to adjust current communication channels to provide additional information not traditionally submitted with network operation requests, reduce the need to increase the ingestion of additional information for training purposes directed to specific network operations, reduce the need for increased computational resources to transmit additional data between components of a computing network, and/or increase processing efficiencies by outputting categorizations that are applicable to other (if not all) network operations originating from the same requestor.

In at least one implementation of the systems and methods described herein, the sequence of prompts may begin with a prompt to categorize the requestor of the network operation execution based on data included in the network operation execution request and/or known information related to the requestor (e.g., information available on the network). The model may then be sequentially prompted (based on the previous response) to generate increasingly narrow outputs until a general category/description of many (if not all) network operations that may be generated by the requestor is outputted. The model may then, in some implementations, be prompted to output a confidence score of the general network operation categorization. An accuracy threshold correlating to the confidence score may be calibrated based on ground truth to limit the use of predicted categorizations to only those that satisfy a predetermined likelihood of accuracy, thus limiting the corruption of downstream data. In some implementations, this requestor-based approach to categorization of network operations through sequential prompting may improve the accuracy of predicted categorization of network operations by reducing overly broad and/or inaccurate categorizations of network operations.

In some aspects, the techniques described herein relate to a method including: executing, by at least one processor, a large language model (LLM) configured to receive an identifier for a set of first computing infrastructures; iteratively transmitting, by the at least one processor, to the LLM an ordered set of prompts for each first computing infrastructure within the set of first computing infrastructures; determining, by the at least one processor, a confidence score for an output of the LLM for each first computing infrastructure within the set of first computing infrastructures, wherein the output of the LLM is a network service description of each first computing infrastructure; evaluating, by the at least one processor, the confidence score for the output of the LLM for each first computing infrastructure using a generated label associated with a first network service description; determining, by the at least one processor, an accuracy threshold for the LLM in accordance with the confidence score; receiving, by the at least one processor, from a second computing infrastructure, a request to execute a network operation; executing, by the at least one processor, the LLM to determine a second network service description associated with the second computing infrastructure; generating, by the at least one processor, a data packet for the network operation including the second network service description determined by the LLM when the second network service description has a second confidence score that satisfies the accuracy threshold; and transmitting, by the at least one processor, data associated with the network operation and the data packet to a second processor configured to execute the network operation.

In some aspects, the techniques described herein relate to a method, further including: retraining, by the at least one processor, the LLM in accordance with the accuracy threshold.

In some aspects, the techniques described herein relate to a method, wherein the LLM is further configured to scan at least one electronic document associated with each first computing infrastructure to determine the first network service description of each first computing infrastructure.

In some aspects, the techniques described herein relate to a method, wherein the ordered set of prompts includes: a first prompt requesting the LLM to provide a category of each first computing infrastructure; a second prompt requesting a type of a network service associated with each category of each first computing infrastructure determined by the LLM in response to the first prompt; a third prompt requesting the first network service description based on the category and the type of the network service determined by the LLM in response to the first prompt and the second prompt; and a fourth prompt requesting the second confidence score associated with the first network service description.

In some aspects, the techniques described herein relate to a method, further including: transmitting, by the at least one processor, the fourth prompt to the LLM, wherein the fourth prompt includes a second request to the LLM to generate the second confidence score for a response by the LLM to at least one of the first prompt, the second prompt, or the third prompt; and receiving, by the at least one processor, the second confidence score for the response generated by the LLM.

In some aspects, the techniques described herein relate to a method, wherein at least one of the ordered set of prompts is transmitted to a second LLM.

In some aspects, the techniques described herein relate to a method, further including: accessing, by the at least one processor, one or more webpages hosted on a first network service; scraping, by the at least one processor, content on the one or more webpages; and inputting, by the at least one processor, the scraped content into the LLM.

In some aspects, the techniques described herein relate to a method, wherein the request to execute the network operation includes an indication of at least one of a second computing infrastructure category, a second computing infrastructure network service type, or the second network service description.

In some aspects, the techniques described herein relate to a method, further including: training, by the at least one processor, the LLM based at least in part on the indication of at least one of the second computing infrastructure category, the second computing infrastructure network service type, or the second network service description.

In some aspects, the techniques described herein relate to a system including: a large language model (LLM); and a computer-readable, non-transitory medium storing instructions that, when executed by one or more processors, cause the one or more processors to: execute the LLM configured to receive an identifier for a set of first computing infrastructures; iteratively transmit to the LLM an ordered set of prompts for each first computing infrastructure within the set of first computing infrastructures; determine a confidence score for an output of the LLM for each first computing infrastructure within the set of first computing infrastructures, wherein the output of the LLM is a network service description of each first computing infrastructure; evaluate the confidence score for the output of the LLM for each first computing infrastructure using a generated label associated with a first network service description; determine an accuracy threshold for the LLM in accordance with the confidence score; receive from a second computing infrastructure, a request to execute a network operation; execute the LLM to determine a second network service description associated with the second computing infrastructure; generate a data packet for the network operation including the second network service description determined by the LLM when the second network service description has a second confidence score that satisfies the accuracy threshold; and transmit data associated with the network operation and the data packet to a second processor configured to execute the network operation.

In some aspects, the techniques described herein relate to a system, wherein the instructions further cause the one or more processors to: retrain the LLM in accordance with the accuracy threshold.

In some aspects, the techniques described herein relate to a system, wherein the LLM is further configured to scan at least one electronic document associated with each first computing infrastructure to determine the first network service description of each first computing infrastructure.

In some aspects, the techniques described herein relate to a system, wherein the ordered set of prompts include: a first prompt requesting the LLM to provide a category of each first computing infrastructure; a second prompt requesting a type of a network service associated with each category of each first computing infrastructure determined by the LLM in response to the first prompt; a third prompt requesting the first network service description based on the category and the type of the network service determined by the LLM in response to the first prompt and the second prompt; and a fourth prompt requesting the second confidence score associated with the first network service description.

In some aspects, the techniques described herein relate to a system, wherein the instructions further cause the one or more processors to: transmit the fourth prompt to the LLM, wherein the fourth prompt includes a second request to the LLM to generate the second confidence score for a response by the LLM to at least one of the first prompt, the second prompt, or the third prompt; and receive the confidence score for the response generated by the LLM.

In some aspects, the techniques described herein relate to a system, wherein at least one of the ordered set of prompts is transmitted to a second LLM.

In some aspects, the techniques described herein relate to a system, wherein the instructions further cause the one or more processors to: access one or more webpages hosted on a first network service; scrape a content on the one or more webpages; and input the scraped content into the LLM.

In some aspects, the techniques described herein relate to a system, wherein the request to execute the network operation includes an indication of at least one of a second computing infrastructure category, a second computing infrastructure network service type, or the second network service description.

In some aspects, the techniques described herein relate to a system, wherein the instructions further cause the one or more processors to: train the LLM based at least in part on the indication of at least one of the second computing infrastructure category, the second computing infrastructure network service type, or the second network service description.

In some aspects, the techniques described herein relate to a computer-readable, non-transitory medium storing instructions that, when executed by one or more processors, cause the one or more processors to: execute a large language model (LLM) configured to receive an identifier for a set of first computing infrastructures; iteratively transmit to the LLM an ordered set of prompts for each first computing infrastructure within the set of first computing infrastructures; determine a confidence score for an output of the LLM for each first computing infrastructure within the set of first computing infrastructures, wherein the output of the LLM is a network service description of each first computing infrastructure; evaluate the confidence score for the output of the LLM for each computing infrastructure using a generated label associated with a first network service description; determine an accuracy threshold for the LLM in accordance with the confidence score; receive from a second computing infrastructure, a request to execute a network operation; execute the LLM to determine a second network service description associated with the second computing infrastructure; generate a data packet for the network operation including the second network service description determined by the LLM when the second network service description has a second confidence score that satisfies the accuracy threshold; and transmit data associated with the network operation and the data packet to a second processor configured to execute the network operation.

In some aspects, the techniques described herein relate to a computer-readable, non-transitory medium, wherein the instructions further cause the one or more processors to: retrain the LLM in accordance with the accuracy threshold.

Various other aspects, features, and advantages of the invention will be apparent through the detailed description of the invention and the drawings attached hereto. It is also to be understood that both the foregoing general description and the following detailed description are examples and are not restrictive of the scope of the invention.

### BRIEF DESCRIPTION OF THE DRAWINGS

FIG. 1 shows an illustrative system for accurately determining a network operation category based on limited network-operation-specific information, in accordance with one more embodiments.

FIG. 2 shows an illustrative block diagram for accurately determining a network operation category based on limited network-operation-specific information, in accordance with one more embodiments.

FIG. 3 shows an illustrative flowchart of a process for accurately determining a network operation categorization based on limited network-operation-specific information through sequential prompting of a machine learning model, in accordance with one or more embodiments.

FIG. 4 shows an illustrative embodiment of the process of FIGS. 2-3, in accordance with one or more embodiments.

FIG. 5 shows a flow diagram of a process for accurately determining a network operation category based on limited network-operation-specific information through sequential prompting of a machine learning model and further calibration of the machine learning model, in accordance with one or more embodiments.

FIG. 6 is a component diagram of an example computing system suitable for use in the various implementations described herein, in accordance with one more embodiments.

The technologies described herein will become more apparent to those skilled in the art by studying the detailed description in conjunction with the drawings. Embodiments of implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

The systems and methods described herein may employ a sequenced, multi-prompt approach to refine and verify LLM predictions when evaluating and generally categorizing an entity's products/services to be able to categorize specific products/services with limited product/service-specific information. These systems implement a paradigm for accurately determining a category of a specific product/service based on a determined general category of the entity's products/services without sufficient information related to the specific product/service. The system and methods described herein may, more specifically, implement a paradigm in which an LLM is sequentially prompted to predict a broad category of the entity down to a general description of the products/services provided by the entity. For example, the LLM may be prompted to categorize a merchant with a computing infrastructure in a network and then be further prompted until the LLM provides a general description/category of the items/services provided by the merchant. Each sequential prompt to the LLM may include information from the output of the LLM in the previous response. This method may be applied such that the final product description of the items or services is broad enough to accurately describe most, if not all, items or services offered by the merchant, and thus be used to categorize most, if not all, items or services being exchanged by the merchant over the network. In this way, specific products/services may be categorized without product/item-specific information being transmitted over the network, thus reducing security risks and computing resource requirements. The LLM may, in some implementations, be prompted to generate a confidence score for one or more of the predictions. The inferred descriptions are labeled based on accuracy (e.g., “Accurate,” “Inaccurate,” or “Broad”), and these labels may be used to calibrate the confidence scoring system and define one or more accuracy thresholds to provide benchmarks for acceptable outputs.

This entity-centric categorization through sequential prompting addresses the limitations of conventional LLMs described herein by reducing the need for product-specific information, thereby reducing the computational resource requirements for data transmission and analysis. Furthermore, these systems and methods enable entities to maintain their existing application programming interfaces (APIs) without requiring additional data exchange between network components, thereby preserving system compatibility and minimizing operational disruptions.

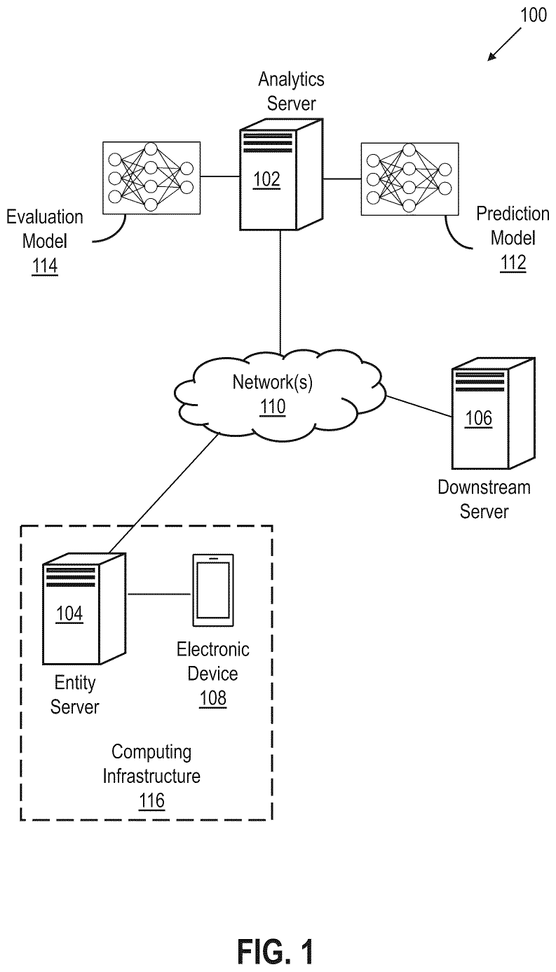

FIG. 1 is a non-limiting example of components of a system described above, shown as system 100. System 100 may use one or more machine learning models to evaluate a network operation request (or the network operation itself) and predict a network service description for a computing infrastructure from which the network operation request is generated/transmitted. As discussed herein, a network operation may be any electronic request causing a server (e.g., an analytics server 102 and/or a downstream server 106). to execute one or more tasks or actions. Non-limiting examples of a network operation may include an API call, an authentication, an electronic transaction, a database query, an encryption, a file upload/download, an HTTP/HTTPS request, and the like.

More specifically, in the system 100, an analytics server 102 may utilize features described in FIGS. 1-5 to predict a network service description for a computing infrastructure 116 from which the network operation request is initiated. The computing infrastructure 116 is associated with one or more entities (e.g., an organization, a merchant, a system, etc.) and may include, but is not limited to, an electronic device 108 and/or a server, shown as an entity server 104. The system 100 is shown as including one or more servers, such as the analytics server 102, the entity server 104, and/or a downstream server 106. The system 100 may include a network 110 which may be configured to communicably couple one or more of the analytics server 102, the entity server 104, the downstream server 106, and/or the electronic device 108. This system 100 may further include a prediction model 112 for predicting the network server description and/or an evaluation model 114 for evaluating the network operation to extract one or more network operation attributes. One or both of the prediction model 112 and/or the evaluation model 114 may be executed on one or more of the servers shown in the system 100. In an embodiment, the prediction model 112 and the evaluation model 114 are executed by the analytics server 102.

In a non-limiting embodiment of the system 100, the analytics server 102 may iteratively prompt the prediction model 112 with an ordered set of prompts to accurately predict a network service description. The ordered set of prompts may end with a prompt to the prediction model 112 to provide a confidence score corresponding to the confidence that one or more of its outputs, in response to the set of prompts, is accurate. This confidence score may be calibrated to determine an accuracy threshold which may be used to limit the use of predictions to those predictions that are likely to be accurate. By way of a non-limiting example, and as is described in greater detail herein, the analytics server 102 of the system 100 may determine that network service description predictions outputted by the prediction model 112 that have a confidence score above 0.85 are 95% likely to be accurate (e.g., 95 predictions out of 100 predictions are accurate). Thus, the system 100 may limit the use of predicted network service descriptions to those that have a confidence level above 0.85.

In some embodiments, the analytics server 102 is communicably coupled with multiple computing infrastructures, such as the computing infrastructure 116, to allow the analytics server to accurately predict a network service description for various computing infrastructures in addition to the computing infrastructure 116. By executing the prediction model 112 and/or the evaluation model 114 for multiple computing infrastructures (such as the computing infrastructure 116) from which network operation requests are initiated, the prediction model 112 may be further fine-tuned by periodically retraining and/or calibrating the prediction model 112 based on newly gathered data from these computing infrastructures. As further described herein, the retraining process may involve incorporating machine learning feedback loops, comparing the model outputs against ground truth, and utilizing advanced machine learning techniques such as transfer learning (e.g., using knowledge from one domain to improve predictions in another domain) or reinforcement learning (e.g., using reward-based feedback to improve decision-making processes).

The system 100 may also include multiple downstream servers, such as the downstream server 106, which may be configured to execute the network operation initiated at the computing infrastructure 116 by the electronic device 108 and transmitted to the analytics server 102 by the entity server 104 through the network 110. The various downstream servers 106 may be associated with various entities. For example, the downstream server 106 may be associated with an authentication agent to execute a network operation such as an authentication request.

For ease of description and understanding, FIG. 1 depicts the system 100 as having only one or a small number of each component. Embodiments may, however, comprise additional or alternative components, or omit certain components, from those of FIG. 1 and still fall within the scope of this disclosure. As an example, it may be common for embodiments to include multiple analytics servers 102 and/or multiple electronic devices 108 that are communicably coupled to the entity server 104. Embodiments may include or otherwise implement any number of devices capable of performing the various features and tasks described herein.

The system 100 may include one or more networks 110, which may include any number of internal networks, external networks, private networks (e.g., intranets, VPNs), and public networks (e.g., Internet). The networks 110 comprise various hardware and software components for hosting and conducting communications among the components of the system 100, such as the entity server 104, the analytics server 102, and/or the downstream server 106. Non-limiting examples of such internal or external networks 110 may include a Local Area Network (LAN), Wireless Local Area Network (WLAN), Metropolitan Area Network (MAN), Wide Area Network (WAN), and the Internet. The communication over the network 110 may be performed in accordance with various communication protocols, such as Transmission Control Protocol and Internet Protocol (TCP/IP), User Datagram Protocol (UDP), and IEEE communication protocols, among others.

The electronic devices 108 may represent various electronic components that receive, retrieve, and/or access data needed to perform one or more network operations, such as processing transactions, facilitating authorization/authentication/verification of accounts, querying databases, and the like. Therefore, the electronic devices 108 may include various hardware and software components. For instance, the electronic devices 108 may include various devices used by a user to access an account hosted by the entity server 104.

The electronic device 108 may be any type of electronic device comprising hardware components (e.g., one or more processors, non-transitory storage) and software components capable of performing the various processes and tasks described herein. Non-limiting examples of the electronic device 108 include personal computers (e.g., laptop computers, desktop computers), server computers, mobile devices (e.g., smartphones, tablets), virtual reality devices, gaming consoles, smart watches, a payment kiosk, a payment terminal, and smart wearables (e.g., rings, watches, eyewear, clothing, etc.), among other types of electronic devices.

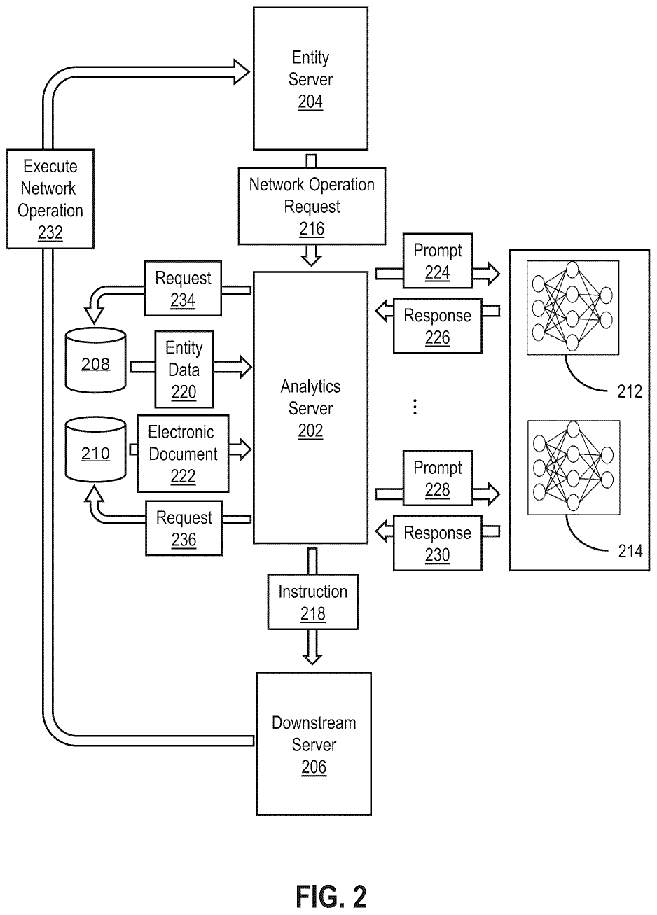

The electronic device 108 may send requests, responses, or other messages to the entity server 104 and/or the analytics server 102 that may require communication with other computing devices or other electronic devices. Additionally, the entity server 104 may include various types of computing units, such as physically separate servers, virtual nodes hosted on one or more physical machines, or nodes on a cloud computing system. Applications, services, or other operations may use data provided by the electronic device 108, entity server 104, the analytics server 102, the downstream server 106, and/or one or more databases (such as shown in FIG. 2), which may include various types of databases, such as SQL databases, no SQL databases, graph databases, etc.

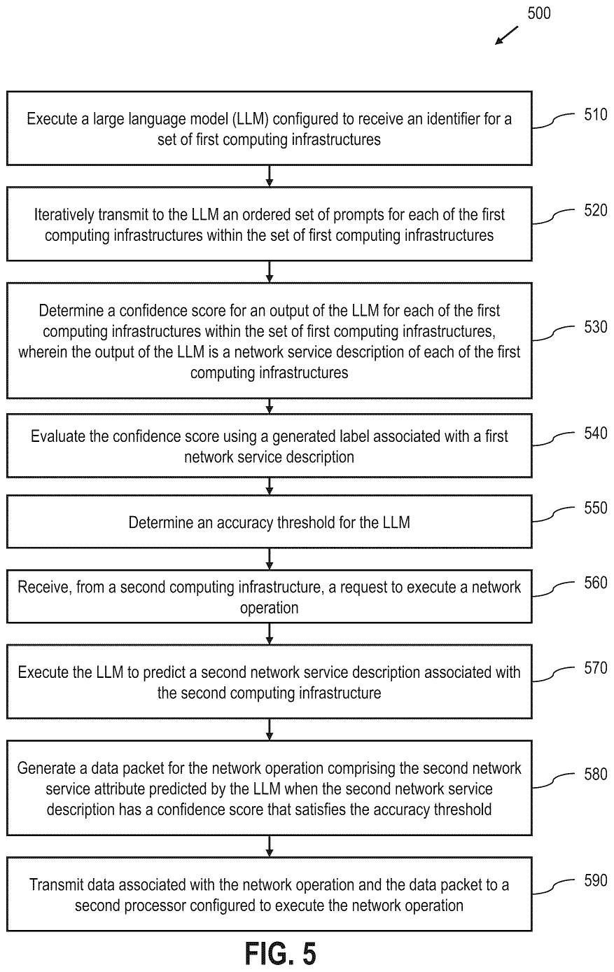

The analytics server 102 may execute one or more software programs to perform various methods and processes described herein (e.g., the method 500 of FIG. 5). The analytics server 102 may include one or more computing devices configured to perform various processes and operations disclosed herein. In some embodiments, the analytics server 102 may be a computer or computing device capable of performing the methods disclosed herein. The analytics server 102 may include a processor and computer-readable, non-transitory medium including instructions, which, when executed by the processor, caused the processor to perform methods disclosed herein. The processor may include any number of physical, hardware processors. Although FIG. 1 shows only a single analytics server 102, the analytics server 102 may include any number of computing devices. In some cases, the computing devices of the analytics server 102 may perform all or portions of the processes and benefits of the analytics server 102. The analytics server 102 may comprise computing devices operating in a distributed or cloud computing configuration and/or in a virtual machine configuration. It should also be appreciated that, in some embodiments, functions of the server 102 may be partly or entirely performed by the electronic device 108, the entity server 104, and/or the prediction model 112.

In some embodiments, the entity server 104 hosts a webpage for presenting one or more network operation options. The webpage which is hosted by the entity server 104 may be accessed by one or more electronic devices, such as the electronic device 108. The electronic device 108 may present the webpage (e.g., visually, audibly, tactilely) on an output device (e.g., a display, an audio device, a haptic engine) of the electronic device 108. Additionally or alternatively, the entity server 104 may facilitate the execution of a network operation (e.g., an authentication request, online transaction, etc.) between one or more of the entity server 104, the downstream server 106, and/or the electronic device 108. Upon accessing the webpage, the electronic device 108 may transmit to the entity server 104 an indication of a request to execute a network operation presented on the webpage. In a non-limiting embodiment, the network operation is an authentication request for accessing data. In some embodiments, the authentication request is executed by an authentication system, which may be associated with the downstream server 106. The downstream server 106 may include one or more computing devices configured to execute one or more software programs to perform various methods and processes, such as, for example, the authentication of the electronic device 108 in response to receiving the authentication request.

Continuing the example of the authentication request, the entity server 104 initially receives the authentication request (e.g., the network operation) from the electronic device 108 and transmits an instruction to the analytics server 102, the analytics server 102 being configured to facilitate the transmission of network operation requests, such as the authentication request, between the entity server 104 and the downstream server 106. The entity server 104 may generate a network operation data package to transmit with the request to the analytics server 102. The network operation data package may include information associated with the network operation, including, by way of a non-limiting example, credentials such as a username and password, an API key, a digital certificate, a transaction amount, etc.

The authentication request and the network operation data package are received by the analytics server 102 and transmitted to the downstream server 106 for execution of the authentication request. The downstream server 106, upon receipt of the request, may validate the credentials against data authentication data (e.g., usernames with corresponding passwords) stored within an authentication system, such as a database or an identity provider. Once the credentials are confirmed as valid, the downstream server 106 may check, in some embodiments, the electronic device 108 permissions or access level to ensure it is authorized to access the requested data. If both authentication and authorization checks are successful, the downstream server 106 generates a session token or access key and transmits it back to the electronic device 108 (e.g., through the analytics server 102 and/or the entity server 104), thus allowing the electronic device 108 to securely access the data. The analytics server 102 may log the network operation for auditing purposes and enforce additional security measures, such as rate limiting or encryption, during the data transmission.

In some instances, the analytics server 102 may be associated with a middleware entity (e.g., an authentication middleware, a commerce platform, etc.) that is distinct from the entity associated with the entity server 104 (e.g., a service provider) and an entity associated with the downstream server 106 (e.g., an authentication provider). As such, it is possible that in the process of facilitating network operation requests and execution, the analytics server 102 does not receive data relating to the purpose of the network operation. Collecting or predicting additional data associated with the network operation, such as an authentication request, that is not explicitly provided by the entity server 104 and/or the downstream server 106 may be beneficial to the analytics server 102 for various reasons. By way of a non-limiting example, the analytics server 102 may use additional data about what the authentication request is for to improve the routing of transmission of authentication requests and to reduce latency and allocation of routing resources. For example, authentication requests from certain entities or for certain purposes may have a higher priority. For example, authentications for medical account authorization, aviation account authorization, first responder account authorization, and the like, may have an elevated priority for transmission. However, the originating entity may not supply this information (e.g., a description of the network operation) to the analytics server 102. As such, by accurately predicting a description of an entity and/or the services/products associated with requested network operations, the analytics server 102 may adjust a routing process of the network operation request, such as prioritizing an allocation of computing resources to the high-priority requests.

However, it is traditionally difficult to automatically determine an accurate description of an entity (e.g., a network service description) when a description is not explicitly provided to the analytics server 102. Further still, it may be technologically efficient to predict, store, and use a single description that accurately describes a variety (if not all) of network operation requests that come from the entity server 104. Such a description may be considered herein as a “network service description.” In some embodiments, the network service description is a general description that may apply to most (if not all) network operation requests that originate from a single computing infrastructure. By predicting, storing, and using a single encompassing network service description for an entity, computing resources are preserved and latency of transmission is reduced because a single prediction can be made once for an entity (or at regular intervals), which can then be used for subsequent requests without needing to re-run the prediction model.

As described above, being able to determine (e.g., predict) an accurate network service description that encompass many, if not all, network operation requests that are transmitted from the entity server associated with the network request may be beneficial, but is technically challenging. The systems and methods descried herein may be used, in at least some embodiments, to overcome the technical challenges described above. To predict a description of the entity associated with the entity server 104, the analytics server 102 may uniquely execute one or more machine learning models, such as the prediction model 112 and/or the evaluation model 114.

Continuing the example of the transmitted authentication request, upon receipt of the authentication request by the analytics server 102 by the entity server 104, the analytics server 102 may transmit the authentication request to the evaluation model 114. The evaluation model 114 may be configured to analyze the authentication request to extract context data related to the authentication request and or the entity server 104. The evaluation model 114 may be trained and implemented using the methods and systems discussed herein. The authentication request transmitted from the entity server 104 may include a data packet comprising data associated with the request. This data may include, among others, an identifier of the requesting user, a user credential, a verification token, a time of request, a priority of request, the purpose of the request, and the like. The analytics server 102 may pass this data to the evaluation model 114 with various prompts to request additional context data associated with one or more information included in the data packet. For example, additional context data may include historical data associated with the user and or the entity server 104, or any other parameter associated with the request. In some instances, the evaluation model 114 may be configured to access additional information outside of the analytics server 102. For example, the evaluation model 114 may utilize the context data of the request to access and scan information (e.g., electronic documents) on the Internet or one or more databases. The evaluation model 114 may collect the scanned data, as accessed, and extract relevant information to pass to the prediction model 112. Relevant information may include, for example, a name of the entity associated with the entity server 104, entity information found on one or more of the entity's webpages, news about the entity, government-required reports, social media account information, etc.

The evaluation model 114 packages the extracted data and transmits it to the analytics server 102. The analytics server 102 receives the relevant information from the evaluation model 114 and generates a prediction request data package with relevant information received from the evaluation model 114 and/or the entity server 104 in the request. The prediction request data may also include one or more prompts for a machine learning model, such as the prediction model 112. The analytics server 102 then transmits the generated prediction request data package to the prediction model 112. As will be described in further detail in FIGS. 2-5, the analytics server 102 may proceed to sequentially prompt the prediction model 112 for various information related to the entity (and/or the computing infrastructure 116) associated with the entity server 104, from which the authentication request was transmitted. Ultimately, the prediction model 112 is configured to provide a network service description of the entity server 104 and a corresponding confidence level of the prediction.

In some embodiments, the predicted network service description as generated by the prediction model 112 may be transmitted by the analytics server 102 to one or more of the entity server 104 and the downstream server 106. The network service description may be transmitted to the entity server 104 for verification of the prediction. In some embodiments, the network service description may be transmitted to the downstream server 106 for logging in a database associated with the downstream server 106 which, in some embodiments, may be accessed by a user account associated with the authentication request. In this way, the entity server 104 and/or the requesting user (through the use of the electronic device 108) may access a log of authentication requests by querying either the entity server 104 or the downstream server 106.

While the network service description is described herein as describing the entity server 104 from which the network operation request is initiated, it is understood that the network service description may apply more generally to the computing infrastructure 116. The computing infrastructure 116 may include the entity server 104 and as such, the network service description may extend, in some embodiments, to accurately describe the computing infrastructure 116. For example, the computing infrastructure 116 may include multiple entity servers associated with the entity, and a predicted network service description of the entity server 104 may be applied more generally to one or more other entity servers associated with the computing infrastructure 116 and/or the entity.

At least one example of a flow of data between the various components of system 100 is shown in FIG. 2. Turning now to FIG. 2, an illustrative block diagram for accurately determining a network operation category without network-operation-specific information is shown, in accordance with one more embodiments. More specifically, a flow of data between various components for executing a prediction model 212 is shown. In at least one embodiment, the prediction model 212 is substantially similar to the prediction model 112 of FIG. 1. In at least one embodiment, the flow of data as shown in FIG. 2 may illustrate a flow of data among one or more of the various components of the system 100 of FIG. 1.

The entity server 204 (which may be substantially similar to the entity server 104 of FIG. 1) may retrieve, receive, or otherwise obtain a request for a network operation from an electronic device, such as the electronic device 108 of FIG. 1. When the entity server 204 receives the request for the network operation, the entity server 204 may transmit a network operation request 216 (along with any enriched data from a system database) to the analytics server 202. In some embodiments, the network operation request 216 is in the form of a data packet, as generated by the entity server 204. The analytics server 202 (which may be substantially similar to the analytics server 102 of FIG. 1) may receive the network operation request 216 and extract one or more parameters from the network operation request 216. These parameters may include, but are not limited to API key, access token, request type (e.g., GET, POST), endpoint URL, request headers, query parameters, body payload, response format (such as JSON or XML), timestamps, username, password, multi-factor authentication token, client ID, client secret, grant type (e.g., password or refresh token), scope of access, transaction ID, payment method, payer and payee details, amount, currency, authentication credentials, encryption signatures for security, a query string (e.g., SQL), database name, connection timeout, filters or sorting options, domain name, record type (e.g., A, CNAME, MX), TTL (time to live), and/or a DNS server's IP address. Additional parameters may include input data, encryption key, encryption algorithm, initialization vector (IV), desired output format (plaintext or ciphertext), a session ID, user token, expiration time, client IP address, user-agent details, file path, file name, file size, content type, authentication token, checksum or hash for verifying data integrity, request headers, content type, response status codes, and caching directives, a request ID, user or device identifier, timestamp, operation type, success or failure status, and/or metadata such as source IP and the accessed endpoint.

In some embodiments, the network operation request 216 parameters are extracted by a machine learning model, such as the evaluation model 214. In some embodiments, the evaluation model 214 may be similar to the evaluation model 114 of FIG. 1 and may be configured to extract information from the network operation request 216. The analytics server 202 may transmit a prompt, such as prompt 228 to the evaluation model 214, the prompt 228 including the network operation request 216 data packet. The evaluation model 214 may analyze the network operation request 216 and extract the relevant information and provide a response 230 to the analytics server 202. However, in some embodiments, the evaluation model 214 is not used to extract information or parameters of the network operation request 216. For example, in some embodiments, the network operation request 216 may be received by the analytics server 202 in a known and expected standard format that the analytics server 202 is able to parse and extract without the evaluation model 214.

In embodiments, in which the evaluation model 214 is used, the evaluation model 214 may analyze the network operation request 216 for its structure, content, and context. It begins by parsing the network operation request 216 into its components, such as, for example, a request line, headers, body, and query string. For instance, in an HTTP request, the model may identify the method (e.g., GET, POST), the URL, headers, and a body payload. The evaluation model 214 may then analyze the parsed data for patterns and keywords associated with network parameters, such as “Authorization,” “Content-Type,” or “Accept” in headers, or fields like “username,” “password,” or “transaction_id” in the body or query string. Training of the evaluation model 214 may allow the evaluation model 214 to analyze the semantic meaning of the data, recognizing, for example, that a token in an “Authorization” header is likely an API key or bearer token. Based on its training on common network operations (such as the network operation associated with the network operation request 216), the evaluation model 214 maps extracted elements to parameter types, such as identifying an IP address as a source identifier, a timestamp as a session parameter, or a file name in a POST request as part of a file upload. Using the context of the request, the evaluation model 214 may output the extracted parameters in a structured and standardized format, such as a JSON object, to transmit to the analytics server 202 and/or the prediction model 212.

By using the evaluation model 214 to extract relevant information from the network operation request 216, the analytics server 202 may receive the network operation request 216 in various formats from various entities with various context data. Indeed, a standardized format for the network operation request 216 may be used when generating the network operation request 216 by the entity server 204, but the standardized format need not be used.

In some embodiments, in response to receiving the network operation request 216 from the entity server 204, the analytics server 202 may make one or more requests to one or more databases, such as a request 234 to an entity database 208 and/or a request 236 to an external database 210. The entity database 208 may be hosted in a computing infrastructure associated with the entity server 204. In some embodiments, the entity server 204 is communicably coupled to the entity database 208. The entity database 208 may be the entity's internal database and includes a structured repository for storing and organizing the entity's data to support operations of the entity. For example, the entity database 208 may include various business/entity information such as employee records, customer/client details, electronic transactions, inventory levels, and operational metrics.

By accessing entity data 220 from the external database 208, the system is able to take advantage of available information not directly provided to the analytics server 202 in the network operation request 216. In this manner, vast amounts of additional contextual data related to the entity server 204 (and by extension, the entity) may be used to accurately categorize the entity (and by extension, network operation request 216) without directly requesting additional contextual data about the entity from the entity server 204. Further, communication channels (e.g., APIs) used for communication between the entity server 204 and the analytics server 202 need not be updated/modified to include additional information not conventionally included in the network operation request 216.

In some embodiments, the entity database 208 is protected with data security, including encryption and authorization requirements. The network operation request 216 received by the analytics server 202 may include an authorization/verification token that may be used to access data stored within the entity database 208. The analytics server 202 may send the request 234 (e.g., a query) to the entity database 208 for entity data 220 that may be used by the prediction model 212 in predicting a network service description of the entity server 204. The request 234 may include the verification/authorization token which may provide access to the entity data 220. The analytics server 202 may either receive from the entity database 208 (or other computing device associated with the entity database 208 such as the entity server 204) or otherwise access the entity data 220 associated with the entity. In some embodiments, the analytics server 202 accesses/receives the entity data 220 through a pluggable component, such as an API.

Additionally or alternatively, the request 236 may request an electronic document 222 from the external database 210. The external database 210 may be a database external to the analytics server 202 and/or the entity server 204. This database may include one or more electronic documents, such as the electronic document 222, retrieved from one or more webpages hosted by one or more webservers. For example, the external database 210 may include scraped data from webpages that have been scanned across the internet. In some embodiments, the scraped content from webpages across the internet (e.g., the electronic document 222) is scanned by the evaluation model 214 and transmitted to the analytics server 202, which passes the scanned data from the electronic document 222 to the prediction model 212 to be inputted into the prediction model 212. The scraped content may include, in some embodiments, all pages of the entity's website, which may be preprocessed, concatenated and included in the contextual data supplied with the set of prompts passed to the prediction model 212, along with their corresponding URLs and creation dates. In some embodiments, the external database 210 may be associated with a single webpage and/or website, for example, the entity's website. In some embodiments, the analytics server 202 may request 236 information from the entity's public website, social media page, or news articles. This data (e.g., the electronic document 222) may be packaged in a data packet to be transmitted to the analytics server 202, prediction model 212, and/or the evaluation model 214 with instructions of a prompt, such as the prompt 224 and/or the prompt 228. In some embodiments, the electronic document 222 has already been ingested by the prediction model 212 and/or the evaluation model 214 during training of the models. In at least one embodiment, the evaluation model 214 is trained on information scraped from various webpages hosted by one or more webservers. Because the network service description of the entity server 204 is, in some embodiments, an encompassing description of the various network operations that may be requested by the entity server 204, data hosted by public webservers on public webpages can prove useful to the evaluation model 214.

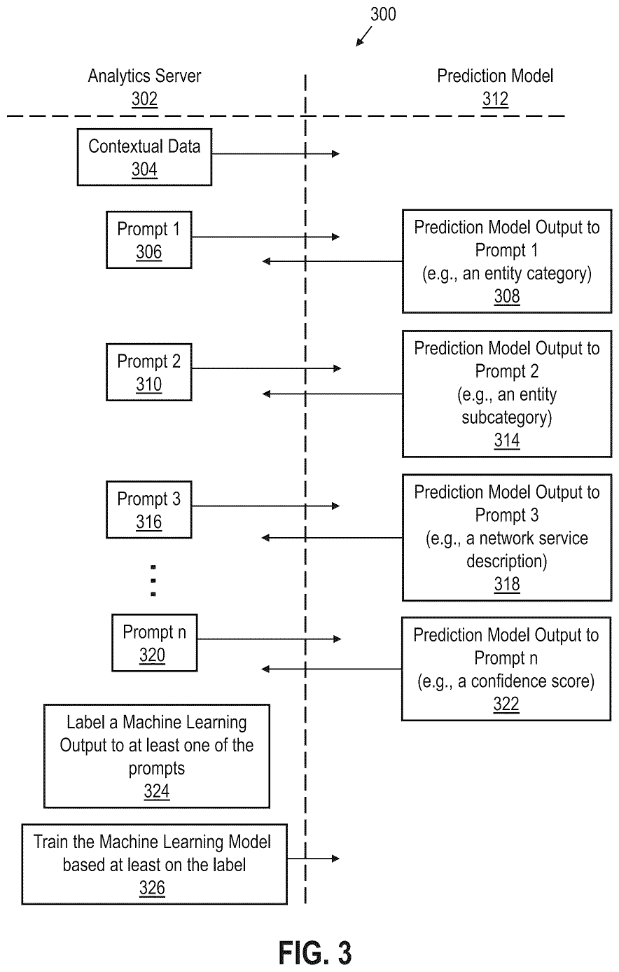

Upon receiving the network operation request 216 from the entity server 204 and any of the entity data 220 from the entity database 208 and/or the electronic document 222 from the external database 210, the analytics server 202 may iteratively transmit an ordered set of prompts 224 to the prediction model 212 to request the prediction model 212 to output a network service description and corresponding confidence score. Turning briefly to FIG. 3, an illustrative flowchart is shown for the iterative and/or sequential prompting of a machine learning model in accordance with a non-limiting embodiment. In some embodiments, the prompt 224 of FIG. 2 is representative of the process 300 shown in FIG. 3.

The process 300 of FIG. 3 may be executed between an analytics server 302 and a prediction model 312. The analytics server 302 may be substantially similar to the analytics server 102 of FIG. 1 and/or the analytics server 202 of FIG. 2. The prediction model 312 may be substantially similar to the prediction model 112 of FIG. 1 and/or the prediction model 212 of FIG. 2.

In some embodiments, the analytics server 302 may transmit to the prediction model 312 an ordered set of prompts to lead the prediction model 312 to ultimately output a network service description of an entity associated with a network operation request received by the analytics server 302. The process 300 may include steps 304, 306, 308, 310, 314, 318, 320, 322, 324, and 326. In some embodiments, the process 300 may include more, fewer, or different steps than those illustrated in FIG. 3.

At step 304, the analytics server 302 may provide contextual data to a machine learning model (e.g., an LLM), such as the prediction model 312. In some embodiments, the prediction model 312 is a large language model designed to process and generate human-like text. However, it is understood that the prediction model 312 may be any of a variety of machine learning models, such as, for example, linear regression, logistic regression, decision trees, random forests, support vector machines, k-nearest neighbors, naïve Bayes, neural networks, convolutional neural networks, recurrent neural networks, transformers, gradient boosting machines, k-means clustering, hierarchical clustering, Gaussian mixture models, principal component analysis, t-distributed stochastic neighbor embedding (t-SNE), autoencoders, generative adversarial networks, reinforcement learning models, and/or deep belief networks.

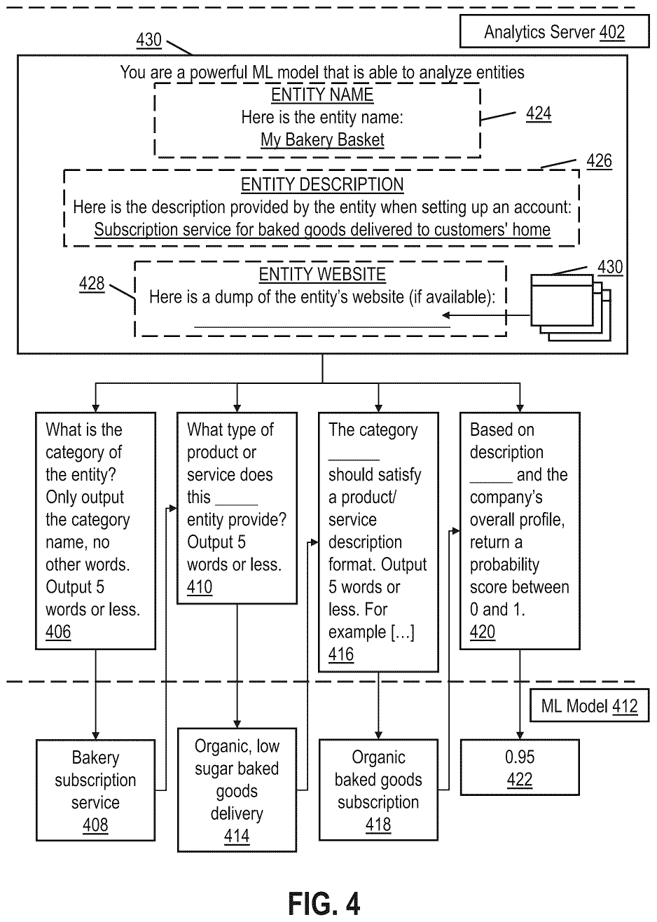

As such, in some embodiments, the contextual data may be provided to the prediction model 312 in natural language with natural language syntax. The contextual data provided to the prediction model 312 at step 304 may include various contextual or background data related to the network operation request and/or the entity associated with the network operation request, thus setting the context for the subsequent prompts. As described herein, the contextual and/or background data may come from one or more databases, such as the entity database 208 and/or the external database 210 of FIG. 2. In some embodiments, the contextual data is retrieved from a database associated with the analytics server 302. For example, during the onboarding of the entity onto a platform associated with the analytics server 302, the entity (through an entity server) may transmit various biographical/descriptive information to the analytics server 302 to be stored in an entity account. In some embodiments, the context data is provided with each iterative prompt as part of the opening statement (as shown in a non-limiting implementation of the process 300 in FIG. 4). However, in some embodiments, the contextual data may be transmitted to the prediction model 312 at the beginning of a conversation session. The prediction model 312 may record the contextual data for the session and access the stored contextual data when generating a response for one or more of the prompts, such as prompt 1, prompt 2, prompt 3, and/or prompt n.

However, in some embodiments, the ordered set of prompts is not sequentially asked in a common/unified/single conversation session. For example, each of the prompts in steps 306, 310, 316, and/or 320 may represent a unique session or call to the prediction model 312. In so doing, the process 300 may be executed on the prediction model 312 without stacking assumptions or hallucinations into subsequent prompt responses. This also reduces bias in the model because the prediction model 312 does not know that the previous information was generated by an LLM (e.g., itself). In other words, at step 306, the analytics server 302 may transmit prompt 1 to the prediction model 312 with the contextual data appended to prompt 1. At step 308, upon receiving prompt 1 from the analytics server 302, the prediction model 312 may execute the large language model and output a response to prompt 1. In an embodiment, the sequential prompts are used to narrow in on a description of services/products provided by an entity requesting the network operation, and ending with a confidence score corresponding to the final output. A non-limiting example of a narrowing set of prompts may include prompts that request the following sequential information: (1) an entity category of the entity associated with the network operation (e.g., a bakery subscription service, a database search engine, an apparel merchant, an authorization processor, etc.), (2) a subcategory of the entity associated with the network operation (e.g., organic, low-sugar baked goods delivery, a national weather database, athletic goods and apparel, software authentication system, etc.), (3) a description of the network operations likely to come from the subcategory from (2) (e.g., organic baked goods subscription, weather data query, athletic equipment, authentication request, etc.). Upon outputting the final description from (3) above (e.g., a network service description), the analytics server 302 requests a confidence score from the prediction model 312.

Accordingly, prompt 1 (from step 306) may be a request for the prediction model 312 to provide a broad category of the entity from which the network operation originated. With this prompt, as described above, the analytics server 302 may include the context data from step 304.

Likewise, upon receiving, at the analytics server 302 from the prediction model 312, a first response to prompt 1 at step 308, the analytics server 302 may sequentially prompt the prediction model 312 with a second prompt at step 310. The second prompt at step 310 may include information from the response at step 308, but transmit the second prompt as a distinct call to the prediction model 312. In so doing, the prediction model 312 does not incorporate any of the previous calculations or analysis into generating a response to the second prompt. This prompt-response sequence may continue through steps 314, 316, 318, 320, and 322. At step 314, the prediction model 312 responds with a second response to prompt 2. The analytics server 302 receives the second response and transmits prompt 3 to the prediction model 312 as a new call to the prediction model 312. Prompt 3 may, in some embodiments, include the contextual data from step 304 and the second response from step 314. For example, prompt 2 may be for a subcategory for the entity associated with the network operation and in prompt 3 the analytics server 302 may further request narrowing the subcategory response from step 314 into a general description of the network operation requested by the entity. In some embodiments, prompt 3 requests that the second response from step 314 be rephrased in a known/standardized format, such as using specific descriptions. This sequence continues until prompt n, which, in some non-limiting embodiments, requests for the prediction model 312 to output a confidence value of the penultimate response.

The confidence score output by the prediction model 312 may be a value (e.g., a numerical measure) that indicates how reliable the prediction model 312 considers its previous response or responses. In some embodiments, the confidence value is expressed as a value between 0 and 1, with a higher score reflecting greater confidence in the response's accuracy, relevance, and alignment with the prompts 1-n. While a scale of 0-1 may be used, alternative confidence ranges may be used, such as 0-100. Similarly, while a higher value is typically used to indicate a higher degree of confidence in a response, a lower score may, in some embodiments, be used to indicate a higher confidence in a response. The prediction model 312 may generate the confidence score based on various factors, including the probability distribution over generated tokens (e.g., words, sub-words, and/or characters), with higher aggregate probabilities indicating stronger confidence in word choices. The prediction model 312 may also take into account how closely the responses from steps 308, 314, and/or 318 align with patterns, facts, or examples in the training data (such as the contextual data passed to the prediction model 312 at step 304), as well as its internal consistency (e.g., with information scraped from the internet), and/or if the response or responses are free from contradictions.

Additionally or alternatively, the prediction model 312 may evaluate how well the response fits within the context of the input data or previous prompts from the analytics server 302 by assessing both semantic and syntactic alignment of the response with the previous responses and/or the context data. In some cases, external validation mechanisms (such as described herein), such as cross-referencing with databases (e.g., the entity database 208 and/or the external database 210 of FIG. 2) or previously labeled ground truth, can further refine the confidence score output at step 322. In some embodiments, the output to prompt n (as shown in step 322) is the confidence score.

The confidence score of the prediction model 312 may be used to determine whether to use the network service description as provided by the prediction model 312. For example, the analytics server 302 may be configured to store the network service description prediction of the entity in a database or other electronic storage medium. However, the analytics server 302 may be further configured to only record the network service description when it is determined that the description is sufficiently likely to be correct. The outputs of the prediction model 312 and their corresponding confidence scores may be analyzed and calibrated by the analytics server 302.

For example, the prediction model 312 may be executed on a training group of data spanning a number of computing infrastructures with corresponding entity servers. The prediction model 312 may be executed for each individual computing infrastructure by iteratively transmitting the ordered set of prompts (and respective contextual data) for each of the computing infrastructures, thus resulting in a network service description and corresponding confidence score for each of the various computing infrastructures for which the prediction model 312 is executed. These network service descriptions for the various computing infrastructures may be compared against a ground truth to determine a correlation between the confidence score in the accuracy of the network service description. Testing of the system and methods described herein, such as process 300, may show a high correlation between the confidence score and the accuracy of the network service description. This correlation may be used to calibrate the confidence scores and/or an accuracy threshold.

The correlation between the confidence scores and the accuracy of the network service descriptions may be used to calibrate the accuracy threshold. This calibration may be executed by the analytics server 302. In at least some embodiments, the accuracy threshold may be used to limit the predicted network service descriptions that are used in subsequent actions by the analytics server 302 and/or other systems. For example, the analytics server 302 may compare the confidence score outputted by the prediction model 312 at step 322 against a determined accuracy threshold (e.g., 0.85). In response to the confidence level exceeding the accuracy threshold (e.g., a confidence score of 0.9), the analytics server 302 may execute one or more subsequent actions, such as generating a data packet for the network operation. The data packet may include, in some embodiments, the network service description corresponding to the satisfying confidence score and one or more attributes of the network operation requested by the entity for which the network service description was generated. This data packet may be stored by the analytics server 302 and/or transmitted to a second server, such as the downstream server 106 of FIG. 1. The second server may or may not be associated with the entity requesting the network operation.

The process by which the analytics server 302 calibrates the accuracy threshold may take one or more various forms. By way of a non-limiting example, the calibration process may include one more rounds of prediction review and subsequent prompt tuning based on outputs of the prediction model 312 and corresponding confidence levels. For example, in a first round of testing, the analytics server 302 provides the prediction model 312 with one or more prompts to generate a network operation description for a plurality of computing infrastructures. Upon receiving the prompt to generate a network service description, the prediction model 312 outputs, based on the methods and systems herein, a predicted network service description associated with each computing infrastructure. A subset of these network service descriptions are then provided to a secondary reviewer (e.g., a review system, the analytics server 302, etc.) to label the network service descriptions with an accuracy label based on a ground truth description. For example, the review system may label each network service description as “Accurate” (e.g., the network service description determined by the prediction model 312 accurately describes most or all network operations that are or may be originated at the computing infrastructure); “Inaccurate” (e.g., the network service description determined by the prediction model 312 does not accurately describe most or all network operations that are or may be originated at the computing infrastructure), or “Broad” (e.g., the network service description determined by the prediction model 312 does describe most or all network operations that are or may be originated at the computing infrastructure, but is not formatted correctly). In some embodiments, the network service description may be required to be in a specified format (e.g., not include certain words or phrases). In these embodiments, for example, an accurate network service description that is nonetheless in an incorrect format, may be labeled as “Broad.”

The accuracy labels may be used to adjust the one or more prompts provided to the prediction model 312, for example, to increase the accuracy of the predictions. Additionally or alternatively, the prompts may be adjusted to inform product description format and provide examples (e.g., employing a few how learning method). The analytics server 302 may prompt the prediction model 312 one or more additional times after the prompt adjustment and subsequently transmit the results to the review system to label the predictions again. The prompts may be further adjusted based on this iterative prompting and labeling approach. In some embodiments, the ratio of accurate (and/or broad) predictions to total predictions may be used by the analytics server 302 to determine a threshold above which a satisfactory amount of accurate predictions are made. For example, the analytics server may determine that 95% of network service descriptions generated by the prediction model 312 with a confidence score above 0.85 are accurate or broad. If 95% accuracy is an acceptable rate of accuracy (e.g., as determined by a preset parameter by the analytics server 302, a down stream server, etc.), then the analytics server may set 0.85 as the accuracy threshold. For example, if the accuracy threshold is calibrated to 0.85, all predictions with a confidence score at or above 0.85 will be used. Conversely, predictions with a confidence score below 0.85 will not be used, stored, transmitted, etc.

Further calibration of the accuracy threshold and prediction model 312 may be executed at a regular cadence (e.g., every 6 months). For example, new network service descriptions with corresponding confidence scores for one or more computing infrastructures may be regenerated by the prediction model 312 and compared against the previously labeled descriptions.

In some embodiments, in response to the confidence score satisfying the accuracy threshold, the analytics server 302 may store the network service description in a database associated with the analytics server 302. In such embodiments, the analytics server 302 may, in some implementations, need not further execute the prediction model 312 when receiving a second network operation from the entity. Rather, the analytics server 302 may extract entity data from the second network operation and compare the entity data to the database in which the analytics server 302 stored the network service description. The analytics server 302 may determine that a network service description is already known for the entity by locating a match between the entity name as extracted from the network operation request and the stored entity information in the database, and continue (without transmitting any prompts to the prediction model 312) to generate a second data packet requesting execution of the network operation to transmit to the second server. In some embodiments, the second data packet includes the previously stored network service description and one or more attributes of the received network operation. In so doing, computational resources are preserved by reducing the need to iteratively execute the prediction model 312 for subsequent network operations originating from the same entity. Rather, the predicted/determined network service description is sufficiently general to apply to most, if not all, of the network operations originating from the same entity, and as such, may be used to categorize many, if not all, network operations originating from the same entity.

The stored network service description may be stored for a predetermined amount of time (e.g., 1 month, 6 months, 1 year) before running the prediction model 312 for the entity again. This may avoid any “stale” descriptions remaining in the database. In some embodiments, the network service description is automatically deleted from the database upon an expiration of the predetermined time period. In such embodiments, the analytics server 302 may receive a null response from a query to the database once the network service description is deleted. Upon receiving the null response, the analytics server 302 may run the process 300 again on the entity/computing infrastructure that originated the network operation that initiated the query to the database. In other embodiments, the analytics server 302 may compare a time of recordation of the saved network service description against a current time or query. If the time between the two times exceeds a predetermined time period (e.g., 1 month, 6 months, 1 year), the analytics server 302 may execute the process 300 again and replace the expired network service description with a new network service description. The new network service description may be saved over the expired network service description and a new expiration clock begins.

In some embodiments, the system automatically runs the process 300 upon expiration of the network service description. For example, in response to the network service description expiring after the predetermined time period, the analytics server 302 may automatically rerun process 300 to update, if necessary, the network service description. In some embodiments, the analytics server 302 may rerun the process 300 for expired descriptions in batches to take advantage of available processors at certain times.

Turning back now to FIG. 2, after the prediction model 212 has returned a response 226, in accordance with the process 300 of FIG. 3, the analytics server transmits an instruction 218 to a downstream server 206. The downstream server 206 may be substantially similar to the downstream server 106 of FIG. 1. In some embodiments, the downstream server 206 may be a server configured to execute the network operation request 216. The instruction 218 may be packaged in a data packet that is transmitted to the downstream server 206 over a network such as the network 110 of FIG. 1. The instruction 218 may include one or more parameters of the network operation request 216, such as an identifier of the requesting entity/user, what is being requested, credentials, a receiving party, etc. In some embodiments, the instruction 218 includes the network service description that is predicted by the prediction model 212. In other embodiments, the instruction 218 does not include the network service description.

In a non-limiting example, when the network operation request 216 is an authentication request from the entity server 204, the downstream server 206 may be associated with an authorization system and configured to receive a user's credentials/verification tokens and generate a corresponding authentication token. Upon verifying that a user making the network operation request has the appropriate credentials to access the requested data, the downstream server 206 executes the network operation 232 and provides the authentication token to the entity server 204 to authenticate the user.

In some embodiments, the analytics server 202 may include the network service description in the instruction 218. For example, in the context in which the network operation request 216 is a request to authorize a user to access data, the analytics server 202 may prioritize some requests over others. For example, as described herein, a request to access a first responder's account may have a higher priority over an authentication of a user accessing a merchant account. As such, the analytics server 202 may, in some instances, transmit with the instruction 218 an indication of the network service description of the entity to the downstream server 206 so that the downstream server 206 may prioritize the network operation request 216.

FIG. 4 is one non-limiting example of an analytics server 402 executing one or more of the systems and methods described in at least FIGS. 1-3 to predict a description of a merchant offering one or more goods for sale. As shown in section 424 of FIG. 4, the merchant is named “My Bakery Basket.” In this example, My Bakery Basket is a baked goods company that offers a subscription service for organic baked goods.

In an embodiment, a user inputs on a webpage associated with My Bakery Basket and hosted by a My Bakery Basket server within My Bakery Basket's computing infrastructure, through the electronic device, a transaction request to purchase a subscription of a monthly baked goods delivery by My Bakery Basket. The entity server receives the submitted transaction request, which is considered a network operation request, from the electronic device. Upon the My Bakery Basket server receiving the transaction request, the My Bakery Basket server generates a first data packet with the transaction request and associated parameters as received from the electronic device. The request parameters may include, for example, a transaction amount, a My Bakery Basket ID (e.g., a routing number), and a user ID (e.g., an account number). The My Bakery Basket server may include in the data packet one or more additional request parameters, such as a name of the entity (e.g., My Bakery Basket). The My Bakery Basket Server transmits the transaction request data packet to the analytics server 402.

The analytics server 402 of FIG. 4 may be substantially similar to the analytics server 102 of FIG. 1, the analytics server 202 of FIG. 2, and/or the analytics server 302 of FIG. 3, and may be configured to execute the systems and methods described herein. The analytics server 402 may receive the transaction request data packet from the My Bakery Basket server. Upon receipt of the transaction request data packet from the My Bakery Basket server, the analytics server 402 extracts the request parameters, as described above. In some embodiments the analytics server 402 transmits the network operation request data packet to a machine learning model, such as the evaluation model 114 of FIG. 1, to extract one or more request attributes, either from the data packet itself or from external databases and/or sources. The evaluation model returns to the analytics server 402 the extracted request parameters. In some embodiments, the analytics server 402 does not transmit the transaction request data packet to the evaluation model, in which case the analytics server 402 extracts the parameters itself. For example, the analytics server 402 may parse the data packet in accordance with a standardized format in which the network operation request data packet is generated. Regardless of the means by which the network operation request parameters are extracted, the analytics server 402 queries a description database communicably coupled to the analytics server 402 to determine if a network service description for My Bakery Basket is known. The analytics server 402 may submit a query to the database with, for example, a query for network service descriptions associated with My Bakery Basket. If no results are returned, the 402 proceeds to execute a prediction process on a machine learning model 412, as illustrated in FIG. 4. The machine learning model 412 may be substantially similar to the prediction model 112 of FIG. 1, the prediction model 212 of FIG. 2, and/or the prediction model 312 of FIG. 3. As shown in section 428, the analytics server 402 may generate a prompt data packet with various data, such as contextual data 430. The contextual data 430 may include, but is not limited to, the requesting entity's name (e.g., My Bakery Basket), a description of the requesting entity (e.g., subscription service for baked goods delivered to customers'homes), and scraped website data of the requesting entity.

For example, contextual data 430 may include background context information that is associated with the requesting entity's name. In the example shown in FIG. 4, the transaction requestor is My Bakery Basket, and as such, My Bakery Basket is included in the contextual data 430. Likewise, a description of My Bakery Basket is included in the contextual data 430. The description may, in some instances, come from a description provided by the entity during onboarding onto a platform associated with the analytics server 402. For example, the analytics server 402 may be associated with a commerce platform, which My Bakery Basket uses to facilitate transactions across one or more downstream servers, such as the downstream server 106 of FIG. 1.

The contextual data 430 may include the entity's name, as shown in section 424. The analytics server 402 inputs the entity name (e.g., My Bakery Basket) into the prompt data packet, as extracted from either the network operation request data packet or the evaluation model. The contextual data 430 may include an entity description, as shown in section 426. The contextual data 430 may also include the data scraped from one or more electronic documents (e.g., a webpage) associated with My Bakery Basket. The one or more electronic documents (e.g., the contextual data 430) may include information from My Bakery Basket's website (e.g., an about page, product descriptions, etc.), a social media account associated with My Bakery Basket, news articles referencing My Bakery Basket, and the like. This contextual data 430 may be appended, in at least one embodiment, to each of the sequential prompts, including prompt 406, prompt 410, prompt 416, and prompt 420. Though, it is understood that the contextual data 430 may also be appended to one or more of the prompts 406, 410, 416, and 420.

The use of contextual data 430 provides a technical benefit by providing a known ground truth by which to assess the outputs of the machine learning model 412. All or some of the contextual data 430 may be supplied by the entity and can be used as a source of truth against which the outputs of the machine learning model 412 are compared. In such a manner, the outputs of the machine learning model benefit from the advantage of utilizing known ground truth for specific network operations, reducing time and computing resources in generating outputs with sufficiently high confidence.

The analytics server 402 may transmit a first prompt data packet including prompt 406 and the contextual data 430. In the embodiment illustrated in FIG. 4, prompt 406 requests the machine learning model 412 to provide a category of My Bakery Basket based on the contextual data 430. Additional limitations may be included in the data packet for prompt 406 to further refine the response of the machine learning model 412. For example, prompt 406 may request that the output be five words or less and only include the category name. Upon receiving this prompt, the machine learning model 412 may execute a large language model and output a response 408. In this embodiment, the response 408 may be a “bakery subscription model.” The response 408 is then returned to the analytics server 402 to be used in the subsequent prompt, prompt 410.

Prompt 410 may request the machine learning model 412 to provide a subcategory of My Bakery Basket by asking what kind of product or services My Bakery Basket provides. This prompt may be amalgamated with the contextual data 430 once again and transmitted as a data packet to the machine learning model 412 as a new call to the machine learning model 412. Upon receipt of the data packet with prompt 410 and the contextual data 430, the machine learning model 412 once again newly executes a session of the large language model to output a subcategory of My Bakery Basket. As shown in FIG. 4, the machine learning model 412 may provide a response 414 that further defines My Bakery Basket by its services by outputting “organic, low sugar baked goods delivery.” Response 414 is transmitted to the analytics server 402 to incorporate in prompt 416 to transmit as a new call to the machine learning model 412. As shown in FIG. 4, the analytics server 402 appends the contextual data 430 to prompt 416 in a data packet to transmit to the machine learning model 412. Prompt 416 may request the machine learning model 412 to provide a final description of the products and/or services that My Bakery Basket offers. The data packet that includes prompt 416 is transmitted to the machine learning model 412, again as a new call to the model. Upon receipt of the data packet, the machine learning model 412 executes the large language model to determine a description that accurately describes the services and/or products of My Bakery Basket. As shown in FIG. 4, the machine learning model 412 uses the subcategory of response 414, prompt 416, and the contextual data 430 to determine a service/product description (also referred to herein as a network service description) for the products being transacted by My Bakery Basket. As shown in FIG. 4, the machine learning model 412 returns an output of a response 418, “organic baked goods subscription.” This response 418 is, once again, transmitted to the analytics server 402 to be used in a subsequent prompt. The final prompt 420 shown in FIG. 4 (though not the final prompt in all implementations of the systems and methods described herein) is a request for the machine learning model 412 to output a confidence score. In some embodiments, the final prompt 420 is transmitted to the machine learning model 412 as a new call to the model. In other embodiments, the prompt 420 is transmitted to a second machine learning model not previously used, thus removing, in some embodiments, bias from the target machine learning model. However, in some embodiments, it may be beneficial to transmit the prompts 420 to the machine learning model 412 (which was used to generate responses 408, 414, and/or 418) because it may understand its limitations and scope of knowledge better than an unassociated machine learning model that provides a confidence score based on observation of the outputs of the machine learning model 412. As shown in FIG. 4, the model (either the machine learning model 412 or an observation model) outputs a confidence score 422. In this embodiment, the confidence score 422 is 0.95.

The confidence score 422 may be transmitted back to the analytics server 402 and/or another server (e.g., the downstream server, the My Bakery Basket server, etc.). In some embodiments, the analytics server 402 receives the confidence score 422 from the machine learning model 412 and compares the confidence score 422 to an accuracy threshold as previously generated/calibrated by the analytics server 402 or other server. If the accuracy score satisfies (e.g., exceeds) the accuracy threshold, the analytics server 402 may store the network service description of the My Bakery Basket in a database associated with the analytics server 402. This data may be used for data analytics by the analytics server 402, such as for determining how to allocate processing resources between network operation requests. Additionally, or alternatively, in response to the confidence score 422 satisfying the accuracy threshold, the analytics server 402 executes a fraud analysis on the transaction. For example, a transaction amount of $2000 to a direct-to-consumer organic baked goods subscription may trigger a fraud alert.

In embodiments, in which the confidence score of the machine learning model's 412 output does not satisfy the accuracy threshold, the analytics server 402 may re-execute the sequential prompts with modified prompts. For example, the prompt may include the previous response to the prompt with instructions that the previous response was incorrect. In other embodiments, the analytics server 402 simply transmits the network operation request data packet to the downstream server (e.g., the authentication server) without saving/transmitting the description.

Turning now to FIG. 5, a method 500 illustrates a flow diagram of steps in a process (such as described in FIGS. 1-4) for accurately determining a network operation category without network-operation-specific information through sequential prompting of a machine learning model and further calibration of the machine learning, in accordance with one or more embodiments. The method 500 may include steps 510-590. In some embodiments, the method 500 may include more, fewer, or different steps than those illustrated as steps 510-590 in FIG. 5.

The steps 510-590 of method 500 may be partially or wholly executed by one or more processors distributed across one or more electronic devices (e.g., servers, user devices, processing circuitry, etc.), such as shown in FIGS. 1-4. In at least one embodiment, the method 500 may be used by a server, such as the analytics server 102 of FIG. 1, the analytics server 202 of FIG. 2, or the analytics server 302 of FIG. 3, to accurately determine a network operation category of a specific network operation without network-operation-specific information through the use of an LLM, such as the prediction model 112 of FIG. 1, the prediction model 212 of FIG. 2, and/or the prediction model 312 of FIG. 3.

In at least one non-limiting embodiment, which is further described below, the analytics server may receive a request to execute a network operation from an entity server, such as the entity server 104 of FIG. 1 and/or the entity server 204 of FIG. 2. The analytics server may execute one or more LLMs to evaluate the network operation, for example, to analyze the request to extract one or more network operation attributes. The analytics server may, in some embodiments, sequentially prompt one or more LLMs (either the same or different than those previously executed) for a network service attribute or description and a corresponding confidence score.

Implementing the method 500 may eliminate or reduce the need for increased data ingestion and/or human training to increase the reliability and accuracy of a machine learning model (e.g., an LLM) by utilizing general computing infrastructure information/categorizations rather than network-operation-specific data, thereby conserving processing resources and reducing latency to scalability. Additionally or alternatively, the implementation of method 500 provides for the accurate prediction of one or more attributes or descriptions of a network operation, such as a network service description of a computing infrastructure, such as described herein. Before implementing the machine learning model, the one or more processors may first train the model. The one or more processors may use various methods to generate a training dataset suitable for the customized training of the model discussed herein.

At step 510, one or more processors may execute an LLM configured to receive an identifier for a set of first computing infrastructures. The one or more processors may be integrated with, or otherwise communicably coupled to, a server that is communicably coupled to one or more devices, such as an electronic device that may access one or more webpages hosted by the server. The server may also be, in some embodiments, coupled to an analytics server associated with a middleware system, configured to facilitate the transmission of network operation requests (e.g., an API request, an authentication request, an electronic transaction, a database query, an encryption, file upload/download request, an HTTP/HTTPS request, and the like). The first set of computing infrastructures may be a collection of computing infrastructures communicably coupled. In some embodiments, the computing infrastructures are distinct from each other and unassociated with each other. Each computing infrastructure may be associated with a separate entity, such as a merchant, organization, and/or system.

Each first computing infrastructure may include a framework of hardware, software, networking, and operational resources that enable computational processes, data storage, and communication within the associated entity, organization, or system. Each computing infrastructure within the set of first computing infrastructures may include various components not shown in FIGS. 1-6, such as hardware (e.g., servers for data processing, storage devices like SSDs and NAS for data storage, and network devices such as routers, switches, etc.). Additionally or alternatively, each first computing infrastructure may include end-user devices, such as the electronic device 108 of FIG. 1, which may represent devices such as computers and smartphones. In addition to hardware, the first computing infrastructures may include software integrated with the hardware. The software layer may include operating systems to manage the above-described hardware and run applications, middleware to enable communication between applications and operating systems, and specific applications tailored for tasks like database management or enterprise resource planning.

As described, the one or more processors of the analytics server (also referred to herein as “the analytics server”) receive, through a network, an indication or identifier for each of the first computing infrastructures. The identifier may be a name of the associated entity, a URL, or any other identifying unit. This identifier may be included in a training dataset which may be used for training the LLM.

At step 520, the one or more processors may iteratively transmit to the LLM an ordered set of prompts for each first computing infrastructure within the set of first computing infrastructures. The ordered set of prompts may include, but are not limited to, a first prompt requesting the LLM to provide a category of each first computing infrastructure; a second prompt requesting a type of a network service associated with each category of each first computing infrastructure predicted by the LLM in response to the first prompt; a third prompt requesting the first network service description based on the category and/or the type of the network service predicted by the LLM in response to the first prompt and the second prompt;

As described, each first computing infrastructure may be associated with a different entity. As an example, each computing infrastructure may represent a merchant's network of servers and point-of-sale devices. In some embodiments, the LLM is configured to predict one or more attributes of the entity associated with each first computing infrastructure. For example, the first prompt to the LLM causes the LLM to output a first attribute (e.g., a category or merchant category) of the entity. The second prompt to the LLM causes the LLM to output a second attribute (e.g., a type of network service or subcategory) of the entity. The third prompt to the LLM causes the LLM to output a third attribute (e.g., a network service description or product description) of the entity. While the first, second, and third attributes are described as a category, type of network service, and a network service description, it is understood that the three attributes may be any attribute of the entity, including but not limited to, an age of the entity, an origin of the entity, valuation of the entity, a merchant category, a subcategory, a product description, etc. The analytics server may iteratively provide the identifier and the ordered set of prompts to the LLM for each of the first computing infrastructures, thereby receiving, in at least one embodiment, a network service description (e.g., a product description) of each of the first computing infrastructures.

At step 530, the one or more processors may determine the confidence score for an output of the LLM for each first computing infrastructure within the set of first computing infrastructures, wherein the output of the LLM is a network description of each first computing infrastructure. In addition to the various prompts, the analytics server may request in a fourth prompt for the LLM to output a confidence score for the third output (e.g., the network service description). In some embodiments, the fourth prompt comprises a second request to the LLM to generate the second confidence score for a response by the LLM to at least one of the first prompt or the second prompt.

At step 540, the one or more processors may evaluate the confidence scores using a generated label associated with the first network service descriptions. For example, the analytics server may compile the confidence scores and associated network service descriptions (e.g., product descriptions). The predicted network service descriptions (or a sampling) may be provided in a graphical interface to one or more reviewers to label the predicted network service descriptions as accurate, inaccurate, and/or broad (e.g., accurate but formatted incorrectly). In some embodiments, the confidence scores are obfuscated from the review to avoid bias. The generated labels from the reviewers may be used to adjust one or more of the prompts to increase the accuracy of the predictions and/or the confidence scores. During the evaluation, a correlation between the confidence scores and the accuracy of the predictions is determined (e.g., predictions with a confidence score above 0.85 are 95% likely to be accurate).

At step 550, the one or more processors may determine an accuracy threshold for the LLM in accordance with the evaluated confidence scores and any determined correlation between accuracy and confidence score. Accuracy of the LLM's predicted network service descriptions (as determined by reviewers) may be highly correlated to the confidence score provided by the LLM to the analytics server. As such, the analytics server is able to determine an accuracy threshold with which to compare the confidence scores of the output of the LLM and thus filter out inaccurate responses.

The confidence level may correspond to the likelihood of accuracy in a response. For example, the analytics server may determine that a confidence level of 0.85 results in 95% accurate results. This percentage may correspond to a target accuracy value, and thus the analytics server may set the accuracy threshold to 0.85. Once the accuracy threshold is set (e.g., 0.85), it may be used to adjust various post-LLM-response actions, such as saving, transmitting, and/or using the predicted network service description by filtering out (e.g., not using) outputs that fall below the accuracy threshold.

By using post-output filtering based on the accuracy threshold, data integrity is maintained. By way of at least one example, filtering out LLM outputs that have a low likelihood of accuracy (e.g., based on a low confidence score) results in those outputs not being stored and/or used for later data analysis, transmission, use, etc. Thus, the system not only produces high-accuracy categorizations of network operations, but it also produces high-accuracy data stemming from the use of the high-accuracy categorizations. System integrity of the LLM also increases due to the high-accuracy outputs.

At step 560, the one or more processors may receive from a second computing infrastructure, a request to execute a network operation. Once the LLM has been trained and the accuracy threshold determined, the LLM may be used to predict network service descriptions of computing infrastructures requesting the execution of network operations. As described elsewhere herein, the analytics server may receive from an entity server within the second computing infrastructure, a request to execute the network operation. By way of an example, and as described herein, the network operation may be an authentication request from the entity to the downstream server.

The request to execute the network operation may come in the form of a data packet with various network operation parameters, such as, in the example of an authentication request, a user's inputted credentials including a username and password. The network operation parameters may be inputted by a user into an electronic device which transmits the request and the corresponding parameters to the entity server which then transmits the network request to the analytics server. In other embodiments, the request parameters (e.g., the username and password) may be stored on the entity server and packaged in the data packet for transmission to the analytics server without user input.

At step 570, the one or more processors may execute the LLM to predict a second network service description associated with the second computing infrastructure. Upon receiving the network operation request, the analytics server may execute the sequential prompting of the LLM based at least in part on the data/parameters received in the data packet with the network operation request. Additionally, the analytics server may execute a secondary machine learning model to extract entity data from the data packet or from external sources (e.g., the internet or external database). The analytics server may use the extracted data from the second machine learning model to input into one or more prompts to the prediction LLM.

The LLM may output, in response to receiving the one or more sequential prompts, a second computing infrastructure category, a second computing infrastructure network service type, and/or a second network service description. In some embodiments, the prompts sequentially lead to the LLM outputting the second network service description. In some embodiments, the LLM is additionally prompted to output a confidence score indicative of the LLM's confidence in the accuracy of its predicted second network service description. In some embodiments, the confidence score is within a scale from 0-1.

At step 580, the one or more processors may generate a data packet for the network operation comprising the second network service description predicted by the LLM when the second network service description has a second confidence score that satisfies the accuracy threshold. The LLM may transmit to the analytics server an indication of the confidence score and one or more outputs in response to the analytics server's prompts from step 570. In response to receiving the confidence score and the one or more responses, the analytics server may compare the confidence score to the previously determined accuracy threshold (e.g., 0.85). If the confidence score satisfies the accuracy threshold (e.g., exceeds 0.85), the analytics server generates a data packet with one or more network operation parameters and the second network service description predicted by the LLM. This data packet is transmitted to the downstream server to which the network operation request was ultimately transmitted. In this example, an authentication server. Having an accurate network service description may aid the analytics server in prioritizing computing resources, thus improving the routing of network operation requests. For example, time-sensitive authentication results (e.g., in the medical context) may be prioritized to be sent to the downstream server and may thus be allocated to open transmission resources, even if the request is not at the front of a queue.

At step 590, the one or more processors may transmit data associated with the network operation and the data packet to a second processor configured to execute the network operation. Upon generation of the data packet, the analytics server transmits the data packet (which may or may not include the network operation request) to a second processor (e.g., the downstream server) which is configured to execute the network operation, such as authenticating a user for data access.

In at least one non-limiting embodiment, the systems and methods described herein may be used by a commerce platform to predict product descriptions of a merchant upon receipt, by the commerce platform from a merchant server, a transaction request. In such embodiments, an analytics server, which may be associated with the commerce platform, executes a prediction model to sequentially predict a category of the merchant, a subcategory of the merchant, and a general product description of products offered by the merchant. The prediction model may then output, in response to a prompt by the analytics server, a confidence score representative of the model confidence is the accuracy of the product description.

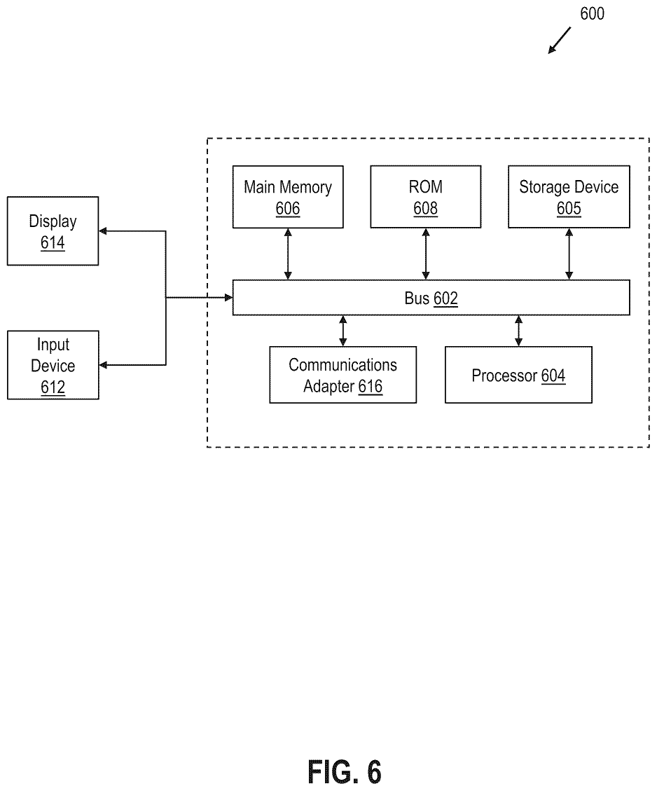

FIG. 6 is a component diagram of an example computing system 600 suitable for use in the various implementations described herein, according to an example embodiment. One or more steps of the methods and processes discussed herein can be performed by the computing system 600 depicted in FIG. 6. The computing system 600 includes a bus 602 or other communication component for communicating information and a processor 604 coupled to the bus 602 for processing information. The computing system 600 also includes main memory 606, such as a RAM or other dynamic storage device, coupled to the bus 602 for storing information, and instructions to be executed by the processor 604. Main memory 606 can also be used for storing position information, temporary variables, or other intermediate information during the execution of instructions by the processor 604. The computing system 600 may further include a ROM 608 or other static storage device coupled to the bus 602 for storing static information and instructions for the processor 604. A storage device 605, such as a solid-state device, magnetic disk, or optical disk, is coupled to the bus 602 for persistently storing information and instructions.

The computing system 600 may be coupled via the bus 602 to a display 614, such as a liquid crystal display, or active-matrix display, for displaying information to a user. An input device 612, such as a keyboard containing alphanumeric and other keys, may be coupled to the bus 602 for communicating information, and command selections to the processor 604. In another implementation, the input device 612 has a touchscreen display. The input device 612 can include any type of biometric sensor, or a cursor control, such as a mouse, a trackball, or cursor direction keys, for communicating direction information and command selections to the processor 604 and for controlling cursor movement on the display 614.

In some implementations, the computing system 600 may include a communications adapter 616, such as a networking adapter. Communications adapter 616 may be coupled to bus 602 and may be configured to enable communications with a computing or communications network or other computing systems. In various illustrative implementations, any type of networking configuration may be achieved using communications adapter 616, such as wired (e.g., via Ethernet), wireless (e.g., via Wi-Fi, Bluetooth), satellite (e.g., via GPS) pre-configured, ad-hoc, LAN, WAN, and the like.

The above-described embodiments of the present disclosure are presented for purposes of illustration and not of limitation, and the present disclosure is limited only by the claims which follow. Furthermore, it should be noted that the features and limitations described in any embodiment may be applied to one or more other embodiments herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods. Furthermore, not all operations of a flowchart need to be performed. In addition, the systems and methods described herein may be performed in real time. It should also be noted that the systems and/or methods described above may be applied to, or used in accordance with, other systems and/or methods.

Furthermore, the computing devices described in this disclosure may be any type of computing device unless otherwise stated, including, but not limited to, a laptop computer, a tablet computer, a hand-held computer, and/or other computing equipment (e.g., a server), including “smart,” wireless, wearable, and/or mobile devices. For example, the electronic device 108 of FIG. 1 may be a smartphone, another type of mobile computing device, or a payment terminal. Furthermore, the embodiments described in this disclosure may include an individual device that performs some or all the operations described in this disclosure. Alternatively, other embodiments may include multiple computing devices acting collectively to perform some or all the operations described in this disclosure.

As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety (i.e., the entire portion), of a given item (e.g., data) unless the context clearly dictates otherwise. Furthermore, a “set” may refer to a singular form or a plural form, such that a “set of items” may refer to one item or a plurality of items.

In some embodiments, the operations described in this disclosure may be implemented in a set of processing devices (e.g., a digital processor, an analog processor, a digital circuit designed to process information, an analog circuit designed to process information, a state machine, and/or other mechanisms for electronically processing information). The processing devices may include one or more devices executing some or all of the operations of the methods in response to instructions stored electronically on one or more non-transitory, machine-readable media (e.g., a set of machine-readable storage media), such as an electronic storage medium. Furthermore, the use of the term “media” may include a single medium or combination of multiple media, such as a first medium and a second medium. A set of non-transitory, machine-readable media storing instructions may include instructions included on a single medium or instructions distributed across multiple media. The processing devices may include one or more devices configured through hardware, firmware, and/or software to be specifically designed for the execution of one or more of the operations of the methods.

In some embodiments, the various computer systems and subsystems illustrated in FIG. 1 or FIG. 2 may include one or more computing devices that are programmed to perform the functions described herein. The computing devices may include one or more electronic storages (e.g., a set of databases accessible to one or more applications depicted in the system 100), one or more physical processors programmed with one or more computer program instructions, and/or other components. For example, the set of databases may include a relational database such as a PostgreSQL™ database or MySQL database. Alternatively, or additionally, the set of databases or other electronic storage used in this disclosure may include a non-relational database, such as a Cassandra™ database, MongoDB™ database, Redis database, Neo4j™ database, Amazon Neptune™ database, etc.

The computing devices may include communication lines or ports to enable the exchange of information with a set of networks (e.g., a network used by the system 100) or other computing platforms via wired or wireless techniques. The network may include the internet, a mobile phone network, a mobile voice or data network (e.g., a 5G or Long-Term Evolution (LTE) network), a cable network, a public switched telephone network, or other types of communication networks or combination of communication networks. A network described by devices or systems described in this disclosure may include one or more communications paths, such as Ethernet, a satellite path, a fiber-optic path, a cable path, a path that supports internet communications (e.g., IPTV), free-space connections (e.g., for broadcast or other wireless signals), Wi-Fi, Bluetooth, near field communication, or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Each of these devices described in this disclosure may also include electronic storages. The electronic storages may include non-transitory storage media that electronically stores information. The storage media of the electronic storages may include one or both of (i) system storage that is provided integrally (e.g., substantially non-removable) with servers or client computing devices, or (ii) removable storage that is removably connectable to the servers or client computing devices via port (e.g., a USB port, a firewire port, etc.) or drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). An electronic storage may store software algorithms, information determined by the processors, information obtained from servers, information obtained from client computing devices, or other information that enables the functionality as described herein.

The processors may be programmed to provide information processing capabilities in the computing devices. As such, the processors may include one or more of a digital processor, an analog processor, a digital circuit designed to process information, an analog circuit designed to process information, a state machine, and/or other mechanisms for electronically processing information. In some embodiments, the processors may include a plurality of processing units. These processing units may be physically located within the same device, or the processors may represent the processing functionality of a plurality of devices operating in coordination. The processors may be programmed to execute computer program instructions to perform functions described herein of subsystems described in this disclosure or other subsystems. The processors may be programmed to execute computer program instructions by software; hardware; firmware; some combination of software, hardware, or firmware; and/or other mechanisms for configuring processing capabilities on the processors.

It should be appreciated that the description of the functionality provided by the different subsystems described herein is for illustrative purposes, and is not intended to be limiting, as any of the subsystems described in this disclosure may provide more or less functionality than is described. For example, one or more of subsystems described in this disclosure may be eliminated, and some or all of its functionality may be provided by other ones of subsystems described in this disclosure. As another example, additional subsystems may be programmed to perform some or all of the functionality attributed herein to one of the subsystems described in this disclosure.

With respect to the components of computing devices described in this disclosure, each of these devices may receive content and data via input/output (I/O) paths. Each of these devices may also include processors and/or control circuitry to send and receive commands, requests, and other suitable data using the I/O paths. The control circuitry may comprise any suitable processing, storage, and/or I/O circuitry. Further, some or all of the computing devices described in this disclosure may include a user input interface and/or user output interface (e.g., a display) for use in receiving and displaying data. In some embodiments, a display such as a touchscreen may also act as a user input interface. It should be noted that in some embodiments, one or more devices described in this disclosure may have neither user input interface nor displays and may instead receive and display content using another device (e.g., a dedicated display device such as a computer screen and/or a dedicated input device such as a remote control, mouse, voice input, etc.). Additionally, one or more of the devices described in this disclosure may run an application (or another suitable program) that performs one or more operations described in this disclosure.

Although the present invention has been described in detail for the purpose of illustration based on what is currently considered to be the most practical and preferred embodiments, it is to be understood that such detail is solely for that purpose and that the invention is not limited to the disclosed embodiments but, on the contrary, is intended to cover modifications and equivalent arrangements that are within the scope of the appended claims. For example, it is to be understood that the present invention contemplates that, to the extent possible, one or more features of any embodiment may be combined with one or more features of any other embodiment.

As used throughout this application, the word “may” is used in a permissive sense (i.e., meaning having the potential to), rather than a mandatory sense (i.e., meaning must). The words “include,” “including,” “includes,” and the like mean including, but not limited to. As used throughout this application, the singular forms “a,” “an,” and “the” include plural referents unless the context clearly indicates otherwise. Thus, for example, reference to “an element” or “the element” includes a combination of two or more elements, notwithstanding the use of other terms and phrases for one or more elements, such as “one or more.” The term “or” is non-exclusive (i.e., encompassing both “and” and “or”), unless the context clearly indicates otherwise. Terms describing conditional relationships (e.g., “in response to X, Y,” “upon X, Y,” “if X, Y,” “when X, Y,” and the like) encompass causal relationships in which the antecedent is a necessary causal condition, the antecedent is a sufficient causal condition, or the antecedent is a contributory causal condition of the consequent (e.g., “state X occurs upon condition Y obtaining” is generic to “X occurs solely upon Y” and “X occurs upon Y and Z”). Such conditional relationships are not limited to consequences that instantly follow the antecedent obtaining, as some consequences may be delayed, and in conditional statements, antecedents are connected to their consequents (e.g., the antecedent is relevant to the likelihood of the consequent occurring). Statements in which a plurality of attributes or functions are mapped to a plurality of objects (e.g., a set of processors performing steps/operations A, B, C, and D) encompass all such attributes or functions being mapped to all such objects and subsets of the attributes or functions being mapped to subsets of the attributes or functions (e.g., both/all processors each performing steps/operations A-D, and a case in which processor 1 performs step/operation A, processor 2 performs step/operation B and part of step/operation C, and processor 3 performs part of step/operation C and step/operation D), unless otherwise indicated. Further, unless otherwise indicated, statements that one value or action is “based on” another condition or value encompass both instances in which the condition or value is the sole factor and instances in which the condition or value is one factor among a plurality of factors.

Unless the context clearly indicates otherwise, statements that “each” instance of some collection has some property should not be read to exclude cases where some otherwise identical or similar members of a larger collection do not have the property (i.e., each does not necessarily mean each and every). Limitations as to the sequence of recited steps should not be read into the claims unless explicitly specified (e.g., with explicit language like “after performing X, performing Y”) in contrast to statements that might be improperly argued to imply sequence limitations (e.g., “performing X on items, performing Y on the X'ed items”) used for purposes of making claims more readable rather than specifying a sequence. Statements referring to “at least Z of A, B, and C,” and the like (e.g., “at least Z of A, B, or C”), refer to at least Z of the listed categories (A, B, and C) and do not require at least Z units in each category. Unless the context clearly indicates otherwise, it is appreciated that throughout this specification discussions utilizing terms such as “processing,” “computing,” “calculating,” “determining,” or the like refer to actions or processes of a specific apparatus, such as a special purpose computer or a similar special purpose electronic processing/computing device. Furthermore, unless indicated otherwise, updating an item may include generating the item or modifying an existing item. Thus, updating a record may include generating a record or modifying the value of an already-generated value in a record. Additionally, as used in the specification, “a portion” refers to a part of, or the entirety of (i.e., the entire portion), a given item (e.g., data) unless the context clearly dictates otherwise.

Unless the context clearly indicates otherwise, ordinal numbers used to denote an item do not define the item's position. For example, an item that may be a first item of a set of items even if the item is not the first item to have been added to the set of items or is otherwise indicated to be listed as the first item of an ordering of the set of items. Thus, for example, if a set of items is sorted in a sequence from “item 1,” “item 2,” and “item 3,” a first item of a set of items may be “item 2” unless otherwise stated.

What is claimed is:

1. A method comprising:
executing, by at least one processor, a large language model (LLM) configured to receive an identifier for a set of first computing infrastructures;
iteratively transmitting, by the at least one processor, to the LLM an ordered set of prompts for each first computing infrastructure within the set of first computing infrastructures;
determining, by the at least one processor, a confidence score for an output of the LLM for each first computing infrastructure within the set of first computing infrastructures, wherein the output of the LLM is a network service description of each first computing infrastructure;
evaluating, by the at least one processor, the confidence score for the output of the LLM for each first computing infrastructure using a generated label associated with a first network service description;
determining, by the at least one processor, an accuracy threshold for the LLM in accordance with the confidence score;
receiving, by the at least one processor, from a second computing infrastructure, a request to execute a network operation;
executing, by the at least one processor, the LLM to determine a second network service description associated with the second computing infrastructure;
generating, by the at least one processor, a data packet for the network operation comprising the second network service description determined by the LLM when the second network service description has a second confidence score that satisfies the accuracy threshold; and
transmitting, by the at least one processor, data associated with the network operation and the data packet to a second processor configured to execute the network operation.

2. The method of claim 1, further comprising:
retraining, by the at least one processor, the LLM in accordance with the accuracy threshold.

3. The method of claim 1, wherein the LLM is further configured to scan at least one electronic document associated with each first computing infrastructure to determine the first network service description of each first computing infrastructure.

4. The method of claim 1, wherein the ordered set of prompts comprises:
a first prompt requesting the LLM to provide a category of each first computing infrastructure;
a second prompt requesting a type of a network service associated with each category of each first computing infrastructure determined by the LLM in response to the first prompt;
a third prompt requesting the first network service description based on the category and the type of the network service determined by the LLM in response to the first prompt and the second prompt; and
a fourth prompt requesting the second confidence score associated with the first network service description.

5. The method of claim 4, further comprising:
transmitting, by the at least one processor, the fourth prompt to the LLM, wherein the fourth prompt comprises a second request to the LLM to generate the second confidence score for a response by the LLM to at least one of the first prompt, the second prompt, or the third prompt; and
receiving, by the at least one processor, the second confidence score for the response generated by the LLM.

6. The method of claim 4, wherein at least one of the ordered set of prompts is transmitted to a second LLM.

7. The method of claim 1, further comprising:
accessing, by the at least one processor, one or more webpages hosted on a first network service;
scraping, by the at least one processor, content on the one or more webpages; and
inputting, by the at least one processor, the scraped content into the LLM.

8. The method of claim 1, wherein the request to execute the network operation comprises an indication of at least one of a second computing infrastructure category, a second computing infrastructure network service type, or the second network service description.

9. The method of claim 8, further comprising:
training, by the at least one processor, the LLM based at least in part on the indication of at least one of the second computing infrastructure category, the second computing infrastructure network service type, or the second network service description.

10. A system comprising:
a large language model (LLM); and
a computer-readable, non-transitory medium storing instructions that, when executed by one or more processors, cause the one or more processors to:
execute the LLM configured to receive an identifier for a set of first computing infrastructures;
iteratively transmit to the LLM an ordered set of prompts for each first computing infrastructure within the set of first computing infrastructures;
determine a confidence score for an output of the LLM for each first computing infrastructure within the set of first computing infrastructures, wherein the output of the LLM is a network service description of each first computing infrastructure;
evaluate the confidence score for the output of the LLM for each first computing infrastructure using a generated label associated with a first network service description;
determine an accuracy threshold for the LLM in accordance with the confidence score;
receive from a second computing infrastructure, a request to execute a network operation;
execute the LLM to determine a second network service description associated with the second computing infrastructure;
generate a data packet for the network operation comprising the second network service description determined by the LLM when the second network service description has a second confidence score that satisfies the accuracy threshold; and
transmit data associated with the network operation and the data packet to a second processor configured to execute the network operation.

11. The system of claim 10, wherein the instructions further cause the one or more processors to:
retrain the LLM in accordance with the accuracy threshold.

12. The system of claim 10, wherein the LLM is further configured to scan at least one electronic document associated with each first computing infrastructure to determine the first network service description of each first computing infrastructure.

13. The system of claim 10, wherein the ordered set of prompts comprise:
a first prompt requesting the LLM to provide a category of each first computing infrastructure;
a second prompt requesting a type of a network service associated with each category of each first computing infrastructure determined by the LLM in response to the first prompt;
a third prompt requesting the first network service description based on the category and the type of the network service determined by the LLM in response to the first prompt and the second prompt; and
a fourth prompt requesting the second confidence score associated with the first network service description.

14. The system of claim 13, wherein the instructions further cause the one or more processors to:
transmit the fourth prompt to the LLM, wherein the fourth prompt comprises a second request to the LLM to generate the second confidence score for a response by the LLM to at least one of the first prompt, the second prompt, or the third prompt; and
receive the confidence score for the response generated by the LLM.

15. The system of claim 13, wherein at least one of the ordered set of prompts is transmitted to a second LLM.

16. The system of claim 10, wherein the instructions further cause the one or more processors to:
access one or more webpages hosted on a first network service;
scrape a content on the one or more webpages; and
input the scraped content into the LLM.

17. The system of claim 10, wherein the request to execute the network operation comprises an indication of at least one of a second computing infrastructure category, a second computing infrastructure network service type, or the second network service description.

18. The system of claim 17, wherein the instructions further cause the one or more processors to:
train the LLM based at least in part on the indication of at least one of the second computing infrastructure category, the second computing infrastructure network service type, or the second network service description.

19. A computer-readable, non-transitory medium storing instructions that, when executed by one or more processors, cause the one or more processors to:
execute a large language model (LLM) configured to receive an identifier for a set of first computing infrastructures;
iteratively transmit to the LLM an ordered set of prompts for each first computing infrastructure within the set of first computing infrastructures;
determine a confidence score for an output of the LLM for each first computing infrastructure within the set of first computing infrastructures, wherein the output of the LLM is a network service description of each first computing infrastructure;
evaluate the confidence score for the output of the LLM for each computing infrastructure using a generated label associated with a first network service description;
determine an accuracy threshold for the LLM in accordance with the confidence score;
receive from a second computing infrastructure, a request to execute a network operation;
execute the LLM to determine a second network service description associated with the second computing infrastructure;
generate a data packet for the network operation comprising the second network service description determined by the LLM when the second network service description has a second confidence score that satisfies the accuracy threshold; and
transmit data associated with the network operation and the data packet to a second processor configured to execute the network operation.

20. The computer-readable, non-transitory medium of claim 19, wherein the instructions further cause the one or more processors to:
retrain the LLM in accordance with the accuracy threshold.
